(19) United States
(12) Patent Application Publication
(10) Pub. No.: US 2026/0201961 A1
(43) Pub. Date: Jul. 16, 2026

(54) BALL VALVE WITH A RETAINING SYSTEM

(71) Applicant: CASTEL S.R.L., Milano (IT)

(72) Inventor: Carlo PIPIA, Milano (IT)

(21) Appl. No.: 19/136,575

(22) PCT Filed: Feb. 19, 2024
(86) PCT No.: PCT/IB2024/051558

§ 371 Date: Jun. 6, 2025

(30) Foreign Application Priority Data
Feb. 22, 2023 (IT) 102023000003072

(51) Int. Cl. F16K 5/06; F16K 15/18

(52) U.S. Cl. CPC F16K 5/0642; F16K 15/1848

(57) ABSTRACT

A ball valve has a body delimiting an inlet section, an outlet section, a central portion interposed between the inlet section and the outlet section, a first path developing between the inlet section and the outlet section for passage of a fluid, a selectively rotatable shutter to allow or prevent the passage of the fluid along the first path, and a second path developing between the inlet section, the shutter and the outlet section. A check valve is positioned along the second path. A pre-established pressure difference between the inlet section and the outlet section determines an opening of the check valve.

The present invention concerns a ball valve comprising a retaining system, configured to selectively intercept a flow along a hydraulic circuit.

In the following, explicit reference will be made to a ball valve with a retaining system that can be used in a refrigeration system, whilst understanding that the aforementioned ball valve with a retention system can be used in other types of hydraulic circuits.

As is known, a ball valve is used to selectively intercept the passage of a fluid through it or, sometimes, to choke it. Among the various field of use of ball valves is refrigeration, in which high operating pressures can be reached. For this reason, the components used must ensure high mechanical resistance to guarantee the hydraulic seal, their correct functioning and, therefore, the safety of the system.

Generally, a ball valve includes a body that has an inlet section, an outlet section and a central portion, in communication with the inlet section and the outlet section, in which a spherical shutter and related annular seals are housed. The latter are configured to create a seal between the central seat and the shutter itself.

The ball shutter delimits a through opening which can be selectively aligned with a delimited passage along the inlet and outlet sections, to place them in fluid communication, following its rotation around a control axis. In practice, the rotation of the shutter inside the central portion allows the hole, passing through the shutter, to be aligned or misaligned with the pipes to which the ball valve is applied, respectively, to allow or prevent the passage of fluid. The ball valve includes a control external to the body of the valve, operationally linked to the ball shutter in such a way that rotating this control determines the rotation of the ball shutter. For example, this control comprises a pin housed in a rotatable manner in the body of the valve, in which the pin has an end which engages a seat made at the top portion of the ball shutter and an opposite end which protrudes externally from the body of the valve.

There are hydraulic sealing elements between the pin and the valve body.

If it is necessary to prevent a reflux of the fluid through the ball valve or if it is necessary to prevent a pressure gradient from exceeding a pre-established threshold value between the inlet section and the outlet section of the ball valve, the use of a check valve operationally connected to the ball valve is known.

Document WO 2012/048369A1 describes a ball valve which includes a retention system, integrated into the body of the valve, wherein the retention system includes a shutter provided with a mobile element, kept in the closed position by an elastic contrast element. When a pressure difference greater than a pre-established threshold value is reached between the inlet section and the outlet section, the force of the elastic element is counteracted and overcome, determining the movement of the mobile element and the opening of the retention system shutter.

A similar ball valve with integrated retaining system has the drawback of not being able to access the check valve in a practical and easy way, for example to carry out maintenance if required.

US 2019/0128431A1 discloses a ball valve comprising a main conduit and a bypass conduit, wherein the valve in turn comprises a first adjusting valve selectively operable to adjust a flow along the main conduit and a second adjusting valve, which can be operated selectively, to adjust a flow along the bypass duct. The activation of both the first and second valves is controlled and does not occur automatically when a pre-established pressure value is exceeded. There is a need in the field to improve the performance of a ball valve including an integrated retention system, with particular reference to the possibility of carrying out easy maintenance.

The aim of the present invention is to simplify the structure of a ball valve including an integrated retention system to facilitate access to the latter.

A further purpose of the present invention is to increase the performance and efficiency of a ball valve with a retention system integrated inside it.

The object of the invention is a ball valve comprising a body which delimits an inlet section, an outlet section and a central portion placed between them as well as a first path, which develops between the inlet section and the outlet section, for the passage of a fluid, a shutter housed in the central portion, in which the shutter is spherical and has a first opening which extends through it, the shutter being selectively rotatable around a control axis to allow or prevent the passage of a fluid along said first path, the body delimiting a second path, bypassing the first path, which develops between the inlet section, the shutter and the outlet section, in which the passage through the shutter occurs through a second opening and a third opening delimited in the shutter and in mutual communication, wherein the ball valve includes a check valve positioned along the second path wherein, when the passage of a fluid along the first path is prevented by the shutter, a pressure difference greater than a pre-established threshold value between the inlet section and the outlet section determines the opening of the check valve.

According to another aspect of the invention, the check valve can comprise a movable shutter and an elastic contrast element which is configured to keep the movable shutter in the closed position until a pre-established threshold value of a gradient is reached and exceeded of pressure between the inlet section and the outlet section.

According to a further aspect of the invention, the check valve can comprise a hollow support in which the mobile shutter is housed, in which the hollow support has an end portion which projects into the central portion of the body and at least partially engages the shutter through the second opening.

According to an additional aspect of the invention, the shutter can be supported for rotation around the control axis by an end portion of the check valve and by a control pin which engages a respective seat delimited in the shutter in a diametrically opposite position with respect to at the second opening.

According to another aspect of the invention, the second path can include a first section and a second section, in succession with each other, both positioned between the inlet section and the shutter, in which the first section departs from the first path and in where the second section develops along a direction parallel to the control axis and places the first section in communication with the inside of the shutter through the second opening.

According to a further aspect of the invention, the second opening can delimit a passage inside the shutter which develops along a direction parallel to the control axis and is in communication with a channel delimited by the first opening and in which the third opening delimits inside the shutter a respective passage which develops along a direction perpendicular to that of the second opening and to that along which the first opening develops.

According to an additional aspect of the invention, when the shutter is in the open position, the first opening can put the inlet section in communication with the outlet section through the first path, occluding the second path and when the shutter is in closed position the first path can be occluded and the second path can be opened, placing the check valve in fluid communication with the inlet section and the outlet section.

According to another aspect of the invention, the ball valve may comprise a first annular seal positioned in the central portion to define a seal along the first path between the shutter and the inlet section, when the shutter is in the closed position and a second annular seal positioned in the central portion to define a seal along the first path between the shutter and the outlet section when the shutter is in the closed position.

According to a further aspect of the invention, the check valve can be positioned along the second section, along a direction parallel to the control axis.

According to an additional aspect of the invention, the ball valve may comprise a plug removably connectable to the body at the central portion to block an access to the second portion through which to access the check valve, in which the check valve is connected removably and tightly to the central portion.

The advantages offered by the ball valve with retention system according to the invention are evident.

The ball valve with retention system which is the subject of the invention has a retention system which, despite being integrated into the body of the ball valve, is easy to access, thus facilitating any maintenance.

In particular, the ball valve with retention system according to the invention has a reduced number of components and an overall simple structure which allows easy access to the inside of the valve and, in particular, to the retention system.

Furthermore, by being able to intervene on the retention system without having to disassemble the entire valve, it is possible to modify the properties of the ball valve with reference to the threshold value of the pressure difference between an inlet section of the ball valve and its outlet section, being able to access and possibly replace the retention system itself according to specific use or design needs.

In other words, if it is not possible to modify the threshold value that determines the opening or closing of the shutter included in the retention system, it is possible to replace the check valve with another one that has different properties in relation to the value of pressure difference threshold that determines its opening or closing.

The present invention will now be described, by way of illustration, but not by way of limitation, according to its preferred embodiments, with particular reference to the figures of the attached drawings, in which:

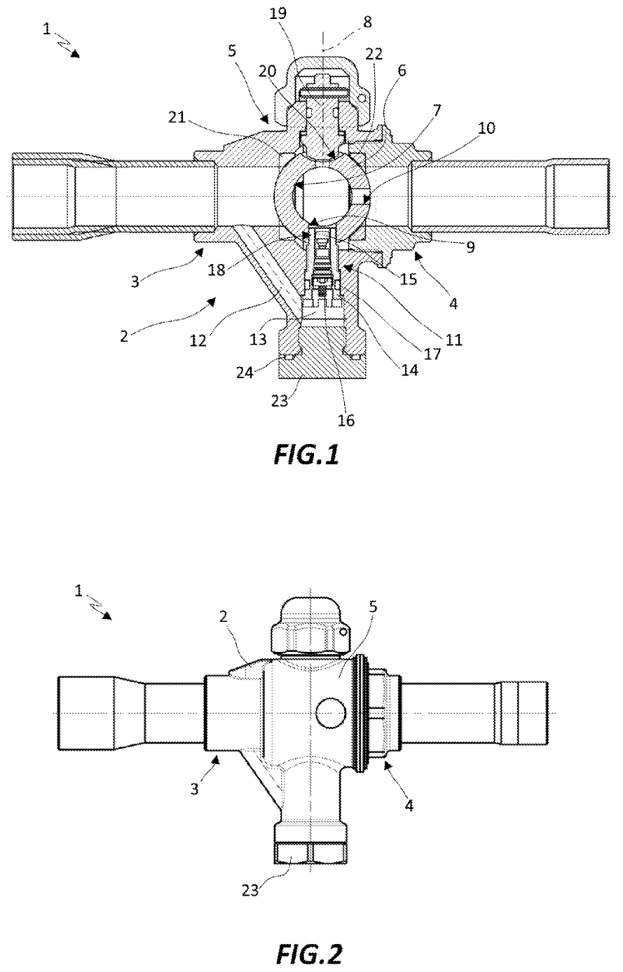

FIG. 1 shows a side view, in section, of a ball valve with a retaining system according to the invention;

FIG. 2 shows a side view of a ball valve with a retaining system according to the invention;

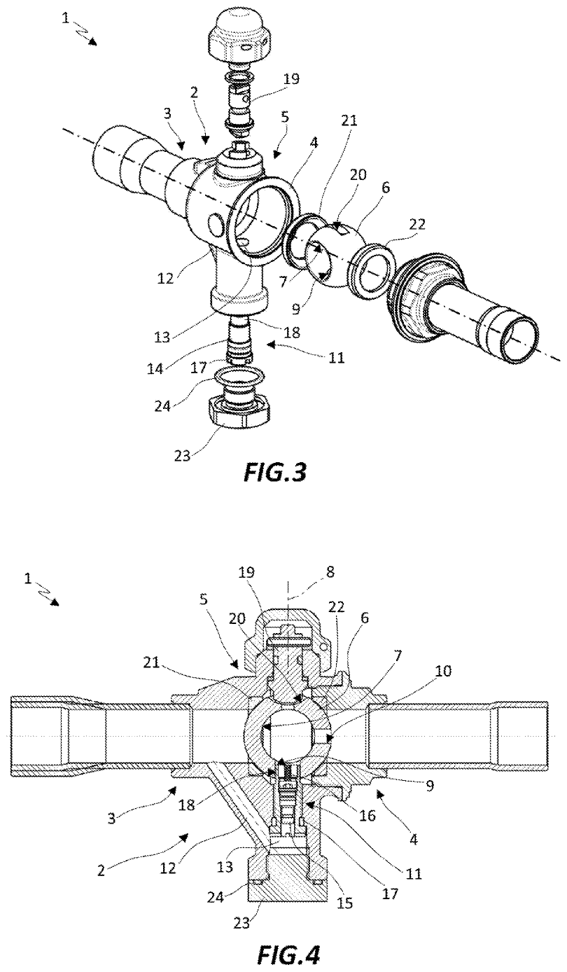

FIG. 3 shows an exploded view of a ball valve with a retaining system according to the invention;

FIG. 4 shows a side view, in section, of a variant of the ball valve with retention system according to the invention.

With reference to the attached Figures, a ball valve with a retention system integrated inside it according to the invention, hereinafter referred to as a ball valve for brevity, is indicated overall with 1.

A ball valve 1 according to the invention includes a body 2 which delimits an inlet section 3, an outlet section 4 and a central portion 5, placed between them.

The inlet section 3 and the outlet section 4 are hollow, to define a passage for a fluid through the body 2 of the ball valve 1.

The body 2, in fact, delimits a first path for the passage of a fluid through the ball valve 1, which develops between the inlet section 3 and the outlet section 4.

The ball valve 1 includes a shutter 6 housed in the central portion 5, configured to selectively intercept the passage of a fluid along the first path.

More in detail, the shutter 6 is of the spherical type and has a first through opening 7 which extends through the entire shutter 6.

Similarly to traditional solutions, the shutter 6 can be selectively rotated around a control axis 8 to allow or prevent the passage of a fluid along the first path depending on the position in which the shutter 6 itself is rotated.

The first through opening 7 develops along a direction perpendicular to the control axis 8, defining a channel passing through the entire shutter 6.

In practice, by rotating the shutter 6, the through channel defined by the first through opening 7 is rotated so as to allow or prevent the passage of a fluid along the first path.

The body 2 further delimits a second path which develops between the inlet section 3, the shutter 6 and the outlet section 4 and is a bypass of the first path. In particular, the passage through the shutter 6 occurs through a second opening 9 and a third opening 10 delimited in the shutter 6 itself (see for example the sectional view of FIG. 1), as will be better described below.

It should be noted that, similarly to what happens in relation to the first path, the second path can also be selectively closed via the shutter 6.

The ball valve 1 includes a check valve 11 configured to selectively occlude or open the second path when the shutter 6 is rotated to the closed position and places the check valve 11 in communication with the inlet section 3 and with the section of outlet 4. In particular, when the shutter 6 is in the closed position, a pressure difference greater than a pre-established threshold value between the inlet section 3 and the outlet section 4 determines the opening of the check valve 11.

As mentioned, this pressure difference detectable by the check valve 11 along the second path occurs when the shutter 6 is placed in the closed position, i.e. it occludes the first path between the inlet section 3 and the outlet section 4, placing the check valve 11 in fluid communication with both the inlet section 3 and the outlet section 4.

It should be noted that the second path includes a first section 12 and a second section 13, placed in succession with each other, both positioned between the inlet section 3 and the shutter 6.

The first section 12 and the second section 13 define a by-pass of the first path.

In accordance with a preferred embodiment illustrated in the attached FIG. 1, the first section 12 departs from the first path, with which it is in fluid communication, while the second section 13 develops along a direction parallel to the control axis 8, placing the first section 12 in communication with the inside of the shutter 6 through the second opening 9.

Preferably, the first section 12 and the second section 13 are linear and are inclined towards each other.

According to a preferred embodiment, the second opening 9 delimits a passage inside the shutter 6 which develops along a direction parallel to the control axis 8. The third opening 10, however, delimits the inside of the shutter 6 a respective passage that develops along a direction perpendicular to that of the second opening 9 (and therefore perpendicular to the control axis 8) and to that along which the first opening 7 develops.

In particular, the second opening 9 and the third opening 10 are in mutual communication through the channel defined by the first through opening 7 (see FIG. 1).

The ball valve 1 is configured in such a way that when the shutter 6 is in the open position, the first through opening 7 puts the inlet section 3 in communication with the outlet section 4 through the first path, occluding the second path. On the contrary, when the shutter 6 is in the closed position, the first path is occluded and the inlet section 3 is placed in communication with the outlet section 4 through the second path and the shutter 6, in particular, through the second opening 9 and third opening 10 delimited in the shutter 6.

According to a preferred embodiment, the check valve 11 includes a hollow support 14 which engages, in a removable manner, a portion of the second section 13, a mobile shutter 15 housed along the hollow support 14 and an elastic contrast element 16, configured to keep the mobile shutter 15 in the closed position until a pre-established pressure difference value between the inlet section 3 and the outlet portion 4 is reached (see FIGS. 1 and 3).

Optionally, the elastic element 16 is of the adjustable type to vary the elastic contrast force applied to the mobile shutter 15, according to methods within the reach of the person skilled in the sector.

By way of example but not by way of limitation, the check valve 11 is screwed inside the second path, along the second section 13. In other words, the hollow support 14 has an external thread which engages a corresponding internal thread delimited along the second section 13, at least in correspondence with the portion engaged by the check valve 11.

It is understood that alternative embodiments are possible, not shown in the attached Figures, in which for example the check valve 11 is kept in position by means of a removable abutment element housed along the second section. For example, a Seeger ring that can be housed in a respective internal seat delimited along the second section and such as to define a stop that prevents the check valve 11 from slipping out of its installation position along the second section 13.

Optionally, the check valve 11 has a gasket 17 positioned externally to the hollow support 14, to define a seal with the central portion 5. In particular, the gasket 17 defines a seal between the hollow support 14 and the second section 13 of the second path (see, for example, FIG. 1).

The hollow support 14 has an end portion 18 which extends into the central portion 5 of the body 2 and engages, at least partially, the second opening 9.

The hollow support 14 acts as a pin for rotating the shutter 6 around the control axis 8.

The shutter 6 is in fact rotatable relative to the check valve 11 and, in particular, relative to the hollow support 14.

Furthermore, the shutter 6, at one of its top portions, is rotatably connected to the body 2 by a control pin 19 which engages a respective seat 20 delimited in the shutter 6 in a diametrically opposite position with respect to the second opening 9.

The shutter 6, being engaged and rotatable at its opposite ends, one at the top and one at the bottom, is guided and kept in correct alignment during its rotation around the control axis 8.

The shutter 6 thus supported is easy to rotate independently of the stresses acting on the shutter 6 itself.

The ball valve 1 includes a first annular seal 21 positioned in the central portion 5 to define a seal along the first path between the outside of the shutter 6 and the inlet section 3, when the shutter 6 is in the closed position and a second annular seal 22 positioned in the central portion to define a seal along the first path between the outside of the shutter 6 and the outlet section 4.

Preferably, the central portion 5 of the ball valve 1 includes respective recesses in which to house the first annular seal 21 and the second annular seal 22, according to methods within the reach of the person skilled in the art which, therefore, will not be described further.

The ball valve 1 includes a cap 23 that can be removably connected to the body 2, at the central portion 5, to block an access opening to the check valve 11.

By way of example but not by way of limitation, the cap 23 is connected along one end of the second section 13, which pertains to the outside of the body 2, via a threaded connection, although it is understood that alternative types of removable mechanical connections are possible, for example via screws.

With reference to the embodiment illustrated in the attached Figures, optionally the ball valve 1 includes a seal 24 placed between the cap 23 and the body 2.

By way of example but not by way of limitation, the seal 24 is shaped like an O-ring housed in an annular seat delimited in the cap 23 (see for example FIG. 3) although it is understood that in an alternative embodiment, not illustrated in the attached Figures, the sealing gasket is flat and therefore the annular seat delimited in the cap 23 is not present.

In a further alternative embodiment, the seal between the cap 23 and the body 2 is determined by their mutual connection and, therefore, no sealing gasket is present.

It should be noted that the second section 13 has an internal diameter such as to allow the insertion or extraction of the check valve 11, to be able to carry out its adjustment, maintenance or to be able to remove it if its replacement is necessary.

With reference to what has been previously described, it appears evident that the ball valve 1 according to the invention is capable of achieving the intended purposes.

The ball valve 1, in fact, includes a retention system integrated inside it which is easy to maintain, as it can be easily reached by removing the cap 23 from the body 2.

If it is necessary to adjust the calibration of the check valve 11 or replace it in case of damage, you can proceed, without removing the ball valve 1 from the hydraulic circuit, by simply removing the cap 23 and accessing the check valve 11 itself.

The ball valve 1 according to the invention has an overall simple structure, comprising a reduced number of components that collaborate synergistically in an integrated solution within the body 2.

The particular configuration of the shutter 6 allows defining inside the body 2 a first path and a second path, independent of each other, for the passage of a fluid between the inlet section 3 and the outlet section 4, as well as for prevent a pressure gradient from being reached between the inlet section 3 and the outlet section 4 above a pre-established threshold value.

The presence of the check valve 11, in fact, guarantees a high operating safety of the ball valve 1, preventing a pressure differential higher than a pre-established threshold value from being reached between the inlet section 3 and the outlet section 4, when the shutter 6 is rotated to the closing position of the first path.

The ball valve 1 according to the invention has a high reliability in the context, as mentioned, of a simple solution and practical maintenance.

The attached FIG. 4 shows an alternative assembly of the check valve 11 which differs from that shown in FIGS. 1-3 in relation to the relative positioning of the mobile shutter and the elastic element 16, the position of which is reversed, although achieving the same advantages described in relation to the preferred embodiment.

In the foregoing, the preferred embodiments have been described and variations of the present invention have been suggested, but it is to be understood that those skilled in the art will be able to make modifications and changes without thereby departing from the relevant scope of protection, as defined by the attached claims.

1. A ball valve comprising:
a body which delimits an input section, an outlet section, a central portion interposed between said input section and said outlet section, and a first path, which develops between said input section and said outlet section for a passage of a fluid, and
a shutter housed in said central portion,
wherein said shutter is spherical and has a first opening which extends through said shutter, said shutter being selectively rotatable around a control axis to allow or prevent the passage of the fluid along said first path,
said body delimiting a second path, bypassing said first path, which develops between said inlet section, said shutter and said outlet section, wherein the passage through said shutter occurs through a second opening and a third opening delimited in said shutter and in mutual communication,
wherein said ball valve further comprises a check valve positioned along said second path, and wherein, when the passage of the fluid along said first path is prevented by said shutter, a pressure difference greater than a pre-established threshold value between said inlet section and said outlet section determines an opening of said check valve.

2. Ball The ball valve of claim 1, wherein said check valve comprises a mobile shutter and a contrasting elastic element configured to keep said mobile shutter in a closed position until a pre-established threshold value of a pressure gradient between said inlet section and said outlet section is reached and exceeded.

3. The ball valve of claim 2, wherein said check valve further comprises a hollow support in which said mobile shutter is housed, and wherein said hollow support has an end portion which projects into said central portion of said body and at least partially engages said shutter through said second opening.

4. The ball valve of claim 3, wherein said shutter is supported for rotation around said control axis by the end portion of said check valve and by a control pin which engages a respective seat delimited in said shutter in a diametrically opposite position with respect to said second opening.

5. The ball valve of claim 1, wherein said second path includes a first section and a second section in succession with each other, both positioned between said inlet section and said shutter wherein said first section departs from said first path, and wherein said second section develops along a direction parallel to said control axis and places said first section in communication with an inside of said shutter through said second opening.

6. The ball valve of claim 1, wherein said second opening delimits a passage inside said shutter which develops along a direction parallel to said control axis and is in communication with a channel delimited by said first opening, and wherein said third opening delimits inside said shutter a respective passage which develops along a direction perpendicular to that of said second opening and to the one along which the first opening extends.

7. The ball valve of claim 1, wherein when said shutter is in an open position, said first opening puts said inlet section in communication with said outlet section through said first path, occluding said second path, and wherein when said shutter is in a closed position said first path is occluded and said second path is open, placing said check valve in fluid communication with said inlet section and with said outlet section.

8. The ball valve of claim 1, further comprising a first annular seal positioned in said central portion to define a seal along said first path between said shutter and said inlet section when said shutter is in a closed position and a second annular seal positioned in said central portion to define a seal along said first path between said shutter and said outlet section when said shutter is in the closed position.

9. Ball The ball valve of claim 5, wherein said check valve is positioned along said second section, along the direction parallel to said control axis.

10. Ball The ball valve of claim 5, further comprising a cap removably connectable to said body at said central portion to block an access to said second section through which to access said check valve wherein said check valve is connected in a removable and sealed manner to said central portion.
